(19) United States
(12) Patent Application Publication
(10) Pub. No.: US 2025/0341283 A1
(43) Pub. Date: Nov. 6, 2025

(54) OPTIMIZED FILLING OF CRYOGENIC TANKS

(71) Applicant: L'Air Liquide, Societe Anonyme pour l'Etude et l’Exploitation des Procedes Georges Claude, Paris (FR)

(72) Inventors: Wassim OUAKRIM, Paris (FR); Joshua LIGHT, Paris (FR)

(21) Appl. No.: 19/195,237

(22) Filed: Apr. 30, 2025

(30) Foreign Application Priority Data
May 3, 2024 (FR) FRFR2404643

(51) Int. Cl. F17C 5/00; F17C 5/02

(52) U.S. Cl. CPC F17C 5/007; F17C 5/02; F17C 2205/037; F17C 2221/012; F17C 2223/0161; F17C 2227/0128; F17C 2250/0417; F17C 2250/043; F17C 2250/0694; F17C 2265/065; F17C 2270/0171; F17C 2270/0189

(57) ABSTRACT

Method for filling a plurality of cryogenic liquid receiving tanks, using a plurality of mobile source tanks, the method comprising the following steps: transferring a first quantity of cryogenic liquid from a first source tank to a first receiving tank, and simultaneous transfer of a first quantity of vaporization gas present in the first receiving tank to the first source tank; checking at least the distribution condition that the pressure in the first source tank is lower than a predetermined pressure threshold; and if the distribution condition is met, transfer of a second quantity of cryogenic liquid from the first source tank to a second receiving tank, and simultaneous transfer of a second quantity of vaporization gas present in the second receiving tank to the first source tank.

### CROSS REFERENCE TO RELATED APPLICATIONS

This application claims the benefit of priority under 35 U.S.C. § 119 (a) and (b) to French patent application No. FR2404643, filed May 3, 2024, which is herein incorporated by reference in its entirety.

### FIELD OF THE INVENTION

This invention relates to a method for filling cryogenic tanks.

### BACKGROUND OF THE INVENTION

A cryogenic liquid is produced at a production site, possibly transported to storage sites, and then distributed to users at distribution sites. Most frequently, the production site includes storage tanks for the produced cryogenic liquid, from which mobile tanks are filled, which will be used for the distribution of the cryogenic liquid. Sometimes the cryogenic liquid is transported to storage sites, where the mobile tanks are filled, which will be used for distribution.

At the distribution sites, a receiving tank is filled with the cryogenic liquid contained in the mobile tank coming from the production site or the storage site. The storage site can thus also be considered as a distribution site. Hereinafter, a source tank is any mobile tank of cryogenic liquid from which the filling of a receiving tank is carried out; a receiving tank is any cryogenic liquid tank, fixed or mobile, which is filled with cryogenic liquid taken from a source tank.

In some cases, the consumption of cryogenic liquid is so important that many source tanks and receiving tanks must be managed on the distribution sites. This is particularly the case for cryogenic liquids used as fuels. The distribution sites must then be able to manage a plurality of source tanks and a plurality of receiving tanks, while optimizing the filling procedures and ensuring the safety of equipment and people. When the cryogenic liquid is a fuel, there is also the problem of eliminating, or at least limiting, greenhouse gas emissions, particularly caused by the venting of the evaporation gases contained in the tanks.

Examples of distribution sites are in particular sites for the filling of vehicle fuel tank, such as fuel filling stations for land vehicles, train stations and airports, fuel tank filling sites for boats and ships.

The desire to use liquid hydrogen as a fuel, in order to meet the challenges of climate change, leads to particular constraints linked to its characteristics and its use. The main problems that arise are linked to the cryogenic nature of liquid hydrogen and to the holding time for tanks, especially mobile tanks, of cryogenic liquids. Because of the heat inputs on the tanks, part of the cryogenic liquid evaporates and generates evaporation gas, also called boil-off gas or “BOG”. The generation of this evaporation gas leads, over time, to a drop in the level of cryogenic liquid in the tank, as well as to a rise in pressure and temperature of the cryogenic liquid. This can pose a problem to ensure that the receiving tanks are filled under good conditions, that is to say in thermodynamic conditions allowing the exploitation and use of the largest quantity of the cryogenic liquid, ideally all of it.

In the particular case of vehicle filling sites, and in particular airports, it is likely that it will be impossible, for safety reasons, to depressurize the receiving tank (for example of an airplane, a car, a truck, a train) or the source tank at the same place where the filling operations are carried out (for example on the airport tarmac, or in the car or truck parking area, or in a train station). It is known, to avoid this problem, to provide a dedicated area for depressurization operations.

It is also known to use, instead of the source tanks, a network of distribution lines making it possible to distribute the cryogenic liquid and recover the evaporation gases. An example is described in the study by G. D. Brewer “LH2 Airport requirements study”, published by NASA in 1976. These systems are expensive to build and allow little flexibility during their operation.

It is also known, for vehicle fuel tanks, to replace an empty tank with a full tank. These solutions impose the use of a greater number of tanks and the establishment of dedicated tank exchange sites which are more complicated to manage than filling sites.

### SUMMARY OF THE INVENTION

In certain embodiments, the present invention is intended to propose a method and a system for filling cryogenic liquid tanks, which overcomes all or part of the drawbacks mentioned above.

In certain embodiments, the invention particularly relates to a method of filling a plurality of cryogenic liquid receiving tanks, in particular cryogenic liquid fuel tanks of vehicles, the cryogenic liquid being in particular liquid hydrogen. The method uses a plurality of mobile source tanks. The method comprises the following steps:
transfer of a first quantity of cryogenic liquid from a first source tank to a first receiving tank, and simultaneous transfer of a first quantity of vaporization gas present in the first receiving tank to the first source tank;
verifying at least the distribution condition that the pressure in the first source tank is lower than a predetermined pressure threshold;
if the distribution condition is respected, transfer of a second quantity of cryogenic liquid from the first source tank to a second receiving tank, and simultaneous transfer of a second quantity of vaporization gas present in the second receiving tank to the first source tank;

The invention may advantageously be applied to the filling of fixed or mobile receiving tanks, in particular semi-trailers for transporting liquefied gases, or on-board cryogenic fuel tanks. The fluids concerned are for example helium, hydrogen, methane, natural gas, or any other fluid or mixture of fluids at cryogenic temperatures.

According to other aspects, the embodiments of the invention may have one or more of the following characteristics.

In an embodiment, at least a fraction of the first quantity of vaporization gas is reliquefied in the first source tank and the first quantity of cryogenic liquid comprises at least a first part of the fraction of reliquefied vaporization gas.

In an embodiment, the verification further comprises verifying the condition that the liquid level in the first source tank is higher than a predetermined liquid level threshold, the distribution condition relating to the liquid level in the source tank preferably being checked before the distribution condition relating to the pressure in the first source tank.

In an embodiment, the second quantity of cryogenic liquid comprises at least a second part of the reliquefied fraction of the first quantity of vaporization gas.

In an embodiment, the method comprises the additional steps of transferring a third quantity of cryogenic liquid from a second source tank to the second receiving tank, and simultaneously transferring a third quantity of vaporization gas present in the second receiving tank to the second source tank, the third quantity of vaporization gas comprising at least an evaporated part of the second quantity of cryogenic liquid.

In an embodiment, when the liquid level in the source tank is higher than the predetermined liquid level threshold but the pressure in the source tank is not lower than the predetermined pressure threshold, the method comprises a step of depressurization of the source tank before the step of transferring the quantity of cryogenic liquid.

In an embodiment, the method uses a tractor vehicle to establish a fluid connection between the source tank and the receiving tank, the at least one distribution condition being checked via at least one pressure and/or liquid level measuring organ, installed on the source tank and/or on the tractor vehicle.

In an embodiment, the tractor vehicle and/or the source tank or tanks comprise a pump configured to make it possible to pump the cryogenic liquid during the cryogenic liquid transfer step.

In an embodiment, the receiving tanks are cryogenic liquid fuel tanks of an aircraft and the method is implemented within the perimeter of an airport.

In an embodiment, the steps of transferring a first quantity of liquid, verifying, transferring a second quantity of liquid are executed, in series, in this order and are preceded by the following preliminary steps.

Establishing a mechanical connection between the first source tank and the tractor vehicle, in a first area of the airport intended for parking the source tanks and the tractor vehicle.

Moving, using the tractor vehicle, the first source tank and the tractor vehicle to a second area of the airport, intended for filling the plurality of receiving tanks.

Establishing a fluid connection between the first receiving tank and the first source tank via the tractor vehicle.

The fluid connection between the first receiving tank and the first source tank via the refueling vehicle is interrupted before checking the at least one cryogenic liquid distribution condition. If the distribution condition is not respected, the first source tank and the tractor vehicle are moved to the first area of the airport, using the tractor vehicle.

### BRIEF DESCRIPTION OF THE DRAWINGS

The invention will be understood better from reading the following description and from studying the accompanying figures. These figures are given only by way of illustration and do not in any way limit the invention.

FIG. 1 schematically and partially represents a first example of a filling method according to the invention.

FIG. 2 schematically and partially represents a second example of a filling method according to the invention.

FIG. 3 represents a schematic and partial view illustrating a first example of a system for implementing a method according to the invention.

FIG. 4 is a schematic and partial view illustrating a second example of a system for implementing a method according to the invention.

FIG. 5 represents a schematic and partial view, illustrating a possible embodiment of a method according to the invention.

### DETAILED DESCRIPTION OF THE INVENTION

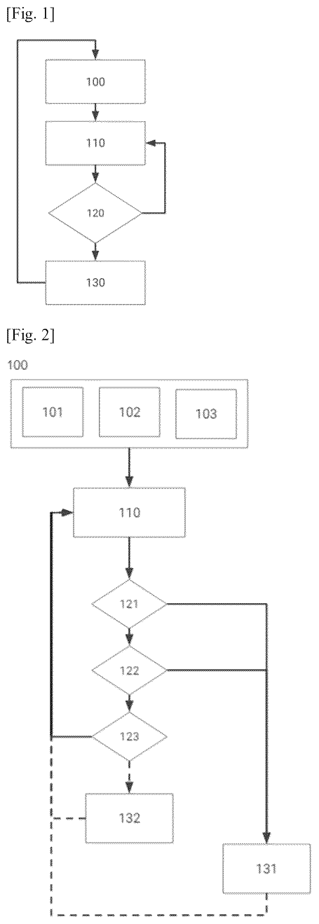

The filling method shown schematically in FIG. 1 and FIG. 5 makes it possible to fill a plurality of receiving tanks 11, 12, 13, 14 with cryogenic liquid and uses a plurality of mobile source tanks 21, 22, 23 and a tractor vehicle 30. The source tanks and the receiving tanks are typically configured to contain a liquid phase and a vapor phase of the cryogenic liquid.

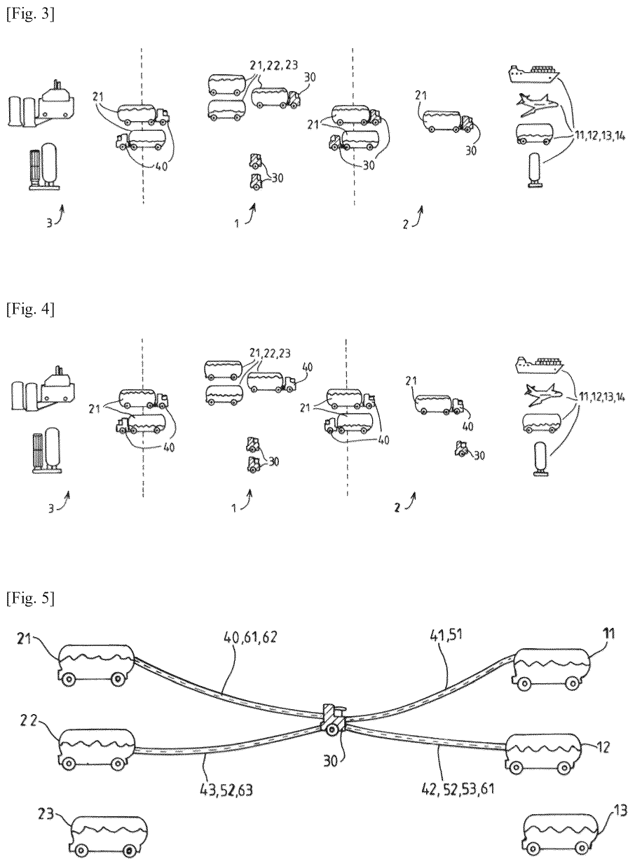

The method can be implemented, for example, as shown in FIG. 3 and FIG. 4, in a distribution site comprising a first zone 1 for parking the source tanks 21, 22, 23 and a second zone 2, separate from the first zone 1, for filling the receiving tanks 11, 12, 13, 14. The first zone 1 is in particular intended to accommodate full source tanks coming from a production or storage site 3, which may be more than 100 km from the distribution site. This distance will depend on the characteristics of the cryogenic liquid to be distributed. In the case of liquid hydrogen, it is typically of the order of 200 km. Site 3 can for example be a liquefier or an intermediate storage site.

The second zone 2 is intended to accommodate the receiving tanks and it is here that the filling operations of the receiving tanks take place. Within the distribution site, the second zone 2 is separated from the first zone 1. For example, the users or owners of the receiving tanks have access only to the second zone 2 and not to the first zone 1. The source tanks 21, 22, 23 are used to transport the cryogenic liquid from the production or storage site 3 to the distribution site. The source tank is a mobile tank and it is preferably mounted on a semi-trailer, towed by a motorized vehicle 40. The source tank can also be installed directly on a motorized vehicle.

One or more tractor vehicles 30 can be provided on the distribution site in order to tow the mobile source tanks within the distribution site and in particular to the second zone 2. The tractor vehicles 30 can be the same motorized vehicles 40 used to tow the source tanks 21, 22, 23 from the production or storage site 3 to the distribution site. The tractor vehicles 30 can also be dedicated motorized vehicles 30, which are permanently on the distribution site. Within the first zone 1, the tractor vehicles 30 can be and remain coupled to a source tank, or else be uncoupled and parked separately from the source tanks.

The method comprises a step of transferring 110 a first quantity 51 of cryogenic liquid from a first source tank 21 to a first receiving tank 11. Preferably, during the step of transferring 110 the first quantity 51 of cryogenic liquid, a first quantity 61 of evaporation gas present in the first receiving tank 11 is simultaneously transferred to the first source tank 21.

The method comprises a verification step 120. At least the distribution condition 121, 122, 123 is checked that the pressure in the first source tank 21 is lower than a predetermined pressure threshold.

When the distribution condition is respected, in particular if the pressure measured in the first source tank 21 is lower than the predetermined pressure threshold, the method comprises a step of transferring 110 a second quantity 52 of cryogenic liquid from the first source tank 21 to a second receiving tank 12. Preferably, during the step of transferring 110 the second quantity 52 of cryogenic liquid, a second quantity 62 of vaporization gas present in the second receiving tank 12 is simultaneously transferred to the first source tank 21.

In an embodiment, at least a fraction of the first quantity of vaporization gas 61 is reliquefied in the first source tank 21 and the first quantity 51 of cryogenic liquid comprises at least a first part of the fraction of reliquefied vaporization gas. The mass of liquid delivered to the first receiving tank is optimized.

The at least partial liquefaction of the evaporation gases injected into the first source tank can be obtained by controlling for this purpose the thermodynamic conditions inside the first source tank, or also the conditions of the injection of the evaporation gas into the first source tank.

In an embodiment, the verification step 120 further comprises checking the condition that the liquid level 121 in the first source tank 21 is higher than a predetermined liquid level threshold. Preferably, the distribution condition relating to the liquid level 121 in the source tank 21, 22 is checked before the distribution condition relating to the pressure 122 in the first source tank 21. The decision to fill or not the second receiving tank is more efficient and the management of the fillings on the distribution site is optimized.

In an embodiment, the second quantity 52 of cryogenic liquid comprises at least a second part of the reliquefied fraction of the first quantity of vaporization gas 61. The quantity of cryogenic liquid actually delivered on the distribution site is maximized, the losses due to the evaporation gases are reduced and the mass of liquid delivered to the second receiving tank is optimized.

In an embodiment, the method comprises an additional step of transferring 110 a third quantity 53 of cryogenic liquid from a second source tank 22 to the second receiving tank 12. Preferably, during the step of transferring 110 the third quantity 53 of cryogenic liquid, a third quantity 63 of vaporization gas present in the second receiving tank 12 is simultaneously transferred to the second source tank 22. The third quantity 63 of vaporization gas comprises at least an evaporated part of the second quantity of cryogenic liquid 52. The recovery of the evaporation gases is ensured and the quantity of cryogenic liquid actually delivered to the distribution site is maximized.

In an embodiment, when the liquid level 121 in the source tank 21, 22 is higher than the predetermined liquid level threshold but the pressure 122 in the source tank 21, 22 is not lower than the predetermined pressure threshold, the method comprises an additional step of depressurizing 132 the source tank 21, 22 before the step of transferring the quantity 51, 52, 53 of cryogenic liquid. The cryogenic liquid in the source tank 21, 22 is thus brought back to thermodynamic conditions favorable to its delivery and/or its use. The quantity of cryogenic liquid actually delivered on the distribution site is maximized.

Depending on the nature of the distribution site, the depressurization step can be implemented in a different suitable area. Preferably, in the case in particular of an airport, a station or similar sites, the depressurization is carried out in the first zone 1.

In an embodiment, the method uses the tractor vehicle 30 to establish a fluid connection between the source tank 21, 22 and the receiving tank 11, 12. The at least one distribution condition 120, 121, 122, 123 is then checked via at least one pressure and/or liquid level measuring organ, installed on the source tank 21, 22, 23 and/or on the tractor vehicle 30.

More generally, the at least one distribution condition 120, 121, 122, 123 can always be checked via at least one pressure and/or liquid level measuring organ, installed on the source tank 21, 22, 23.

In an embodiment, the tractor vehicle 30 and/or the source tank or tanks 21, 22, 23 comprise a pump configured to make it possible to pump the cryogenic liquid during the cryogenic liquid transfer step. The thermodynamic efficiency of the transfer is improved. The transferred flow rate can be controlled more flexibly, for example in real time.

In an embodiment, the receiving tanks 11, 12, 13 are aircraft cryogenic liquid fuel tanks and the method is implemented within the perimeter of an airport 1, 2.

The steps of transferring a first quantity of liquid 51, verifying 120, transferring a second quantity of liquid 52 can be executed, in series, in this order.

Prior to carrying out these steps in the second zone 2 of the airport, a step of establishing a mechanical connection between the first source tank 21 and the tractor vehicle 30 can be carried out in the first zone 1 of the airport.

The movement 101, 102, using the tractor vehicle 30, of the first source tank 21 and the tractor vehicle 30 towards the second zone 2 of the airport can then be carried out.

Finally, a step of establishing a fluid connection between the first receiving tank 11 and the first source tank 21 via the tractor vehicle 30 can be carried out in the second zone 2.

Preferably, the fluid connection 41 between the first receiving tank 11 and the first source tank 21 via the refueling vehicle 30 is interrupted before checking 120 of the at least one cryogenic liquid distribution condition. If the distribution condition 121, 122, 123 is not respected, the first source tank 21 and the tractor vehicle 30 can then be moved to the first area 1 of the airport, using the tractor vehicle 30.

In an embodiment, the method comprises, in series and in order, the following steps.

Establishment 103 of a fluid connection 40, 41 between a first receiving tank 11 and a first source tank 21 via the refueling vehicle 30.

Transfer of 110 a first quantity 51 of liquid cryogenic fuel from the first source tank 21 to the first receiving tank 11 via the refueling vehicle 30, and simultaneous transfer of a first quantity 61 of vaporization gas present in the first receiving tank 11 to the first source tank 21 via the refueling vehicle 30.

Verifying 120 at least one condition 121, 122, 123 for distributing liquid cryogenic fuel, in particular that the pressure in the first source tank 21 is lower than a predetermined pressure threshold.

If the at least one fuel distribution condition is respected, establishment 103 of a fluid connection 40, 42 between a second receiving tank 12 and the first source tank 21 via the refueling vehicle 30, then transfer 110 of a second quantity 52 of liquid cryogenic fuel from the first source tank 21 to the second receiving tank 12 via the refueling vehicle 30, and simultaneous transfer of a second quantity 62 of vaporization gas present in the second receiving tank 12 to the first source tank 21 via the refueling vehicle.

In an embodiment, the tractor vehicle 30 comprises a fluid circuit provided with a set of valves, lines and fluid control organs such as a pump or a compressor. The tractor vehicle 30 may also comprise an electronic controller, or another equivalent device, configured to control at least part of the valves, lines and control organs in order to execute a method according to the invention.

In an embodiment, a fluid and/or mechanical connection is established between the source tank and the tractor vehicle 30 in the second zone 2, near the receiving tank.

In an embodiment, the fluid and/or mechanical connection is established between the source tank and the tractor vehicle 30 in the first zone 1 or in a third zone of the distribution site, remote from the receiving tank.

In an embodiment, the source tanks are configured to receive and keep the cryogenic liquid in a subcooled state. A liquid is in a subcooled state when its temperature is lower than the saturation temperature corresponding to the pressure at which the liquid is, or its pressure is higher than the saturation pressure corresponding to the temperature at which the liquid is.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

1. A method for filling a plurality of cryogenic liquid receiving tanks comprising cryogenic liquid fuel tanks of vehicles, the cryogenic liquid comprising liquid hydrogen, the method using a plurality of mobile source tanks, the method comprising the following steps:
transferring a first quantity of cryogenic liquid from a first source tank to a first receiving tank, and simultaneously transferring a first quantity of vaporization gas present in the first receiving tank to the first source tank;
verifying whether a distribution condition is met, wherein the distribution condition comprises determining whether a pressure in the first source tank is lower than a predetermined pressure threshold; and
upon verification that the distribution condition is met, transferring a second quantity of cryogenic liquid from the first source tank to a second receiving tank, and simultaneously transferring of a second quantity of vaporization gas present in the second receiving tank to the first source tank.

2. The method according to claim 1, wherein at least a fraction of the first quantity of vaporization gas is reliquefied in the first source tank and wherein the first quantity of cryogenic liquid comprises at least a first part of the reliquefied fraction of vaporization gas.

3. The method according to claim 1, wherein the verification further comprises checking the condition that the liquid level in the first source tank is higher than a predetermined liquid level threshold, the distribution condition relating to the liquid level in the source tank preferably being checked before the distribution condition relating to the pressure in the first source tank.

4. The method according to claim 3, wherein, when the liquid level in the source tank is higher than the predetermined liquid level threshold but the pressure in the source tank is not lower than the predetermined pressure threshold, the method comprises a step of depressurizing the source tank before the step of transferring the quantity of cryogenic liquid.

5. The method according to claim 1, wherein the second quantity of cryogenic liquid comprises at least a second part of the reliquefied fraction of the first quantity of vaporization gas.

6. The method according to claim 5, wherein, when the liquid level in the source tank is higher than the predetermined liquid level threshold but the pressure in the source tank is not lower than the predetermined pressure threshold, the method comprises a step of depressurizing the source tank before the step of transferring the quantity of cryogenic liquid.

7. The method according to claim 1, further comprising the additional steps of transferring a third quantity of cryogenic liquid from a second source tank to the second receiving tank, and simultaneously transferring a third quantity of vaporization gas present in the second receiving tank to the second source tank, the third quantity of vaporization gas comprising at least an evaporated part of the second quantity of cryogenic liquid.

8. The method according to claim 7, wherein, when the liquid level in the source tank is higher than the predetermined liquid level threshold but the pressure in the source tank is not lower than the predetermined pressure threshold, the method comprises a step of depressurizing the source tank before the step of transferring the quantity of cryogenic liquid.

9. The method according to claim 1, further comprising using a tractor vehicle to establish a fluid connection between the source tank and the receiving tank, and checking the distribution condition via at least one pressure and/or liquid level measuring device, installed on the source tank and/or on the tractor vehicle.

10. The method according to claim 9, wherein the tractor vehicle and/or the source tank or tanks comprise a pump configured to make it possible to pump the cryogenic liquid during the cryogenic liquid transfer step.

11. The method according to claim 1, wherein the receiving tanks are aircraft cryogenic liquid fuel tanks and in that the method is implemented within the perimeter of an airport.

12. The method according to claim 11, wherein the steps of transferring a first quantity of liquid, verifying, transferring a second quantity of liquid are executed, in series, in this order and are preceded by the following preliminary steps:
establishing a mechanical connection between the first source tank and the tractor vehicle, in a first zone of the airport intended for parking the source tanks and the tractor vehicle;
moving, using the tractor vehicle, the first source tank and the tractor vehicle to a second zone of the airport, intended for filling the plurality of receiving tanks; and
establishing a fluid connection between the first receiving tank and the first source tank via the tractor vehicle,
wherein the fluid connection between the first receiving tank and the first source tank via the refueling vehicle is interrupted before checking the at least one cryogenic liquid distribution condition; and, if the distribution condition is not respected, the first source tank and the tractor vehicle being moved to the first zone of the airport, at the using the tractor vehicle.
